(19) United States
(12) Patent Application Publication
(10) Pub. No.: US 2025/0022005 A1
(43) Pub. Date: Jan. 16, 2025

(54) System and Method to Determine List Prices Based on Cash Incentives and Transaction Costs

(71) Applicant: Parse Pay, Inc., Roseville, CA (US)

(72) Inventor: Mark Hardwick, Rocklin, CA (US)

(73) Assignee: Parse Pay, Inc., Roseville, CA (US)

(21) Appl. No.: 18/773,074

(22) Filed: Jul. 15, 2024

Related U.S. Application Data
(60) Provisional application No. 63/526,645, filed on Jul. 13, 2023.

(51) Int. Cl. G06Q 30/0207; G07G 1/00

(52) U.S. Cl. CPC G06Q 30/0213; G07G 1/0009

(57) ABSTRACT

A system and method for dynamically calculating prices and processing payments in credit/debit card transactions is disclosed. The system determines processing costs and adjusts item prices accordingly, considering cash prices, tax profiles, and cash payment discounts. Users configure a Cash Discount Rate for cash payments, from which the system generates an Effective Rate for card transactions. The system then calculates either a Listed Price based on a given Cash Price, or vice versa, incorporating the cost of card processing. The system also manages partial payments at the point of sale by dynamically adjusting cash discounts and tax amounts. For partial cash payments, it calculates a prorated cash discount and recalculates tax to determine the remaining card due. Similarly, for remaining cash due after partial card payments, it reduces the cash discount proportionally and recalculates tax. These features ensure accurate pricing and discounts across various payment scenarios, optimizing transaction processing.

### CROSS-REFERENCE TO RELATED APPLICATIONS

This application claims priority under 35 U.S.C. Section 119 (e) to co-pending U.S. Provisional Patent Application No. 63/526,645, entitled “System and Method to Determine List Prices Based on Cash Incentives and Transaction Costs” and filed on Jul. 13, 2023, the entire disclosure of which is incorporated herein by reference.

### FIELD

This invention pertains generally to determining listed prices for card-payment transactions based on an item's cash price, an incentive to pay with cash, and the amount to cover the cost of processing card-payment transactions.

### BACKGROUND

Each time a merchant accepts and processes a payment transaction, they pay a processing fee, often referred to as a merchant service fee, to the appropriate financial institution. Aside from labor and material costs, merchant service fees are one of the largest expenses businesses such as restaurants incur.

Implementing a payment processing program designed to offset the cost of merchant service fees has become increasingly common, and businesses and their customers widely accept them.

One method of offsetting the cost of processing fees is to implement a credit card surcharge, which is a fee charged by the merchant to compensate for some of the cost of payment processing. However, major credit card institutions set rules and regulations for merchants to follow when implementing surcharges, and presently, some states have banned surcharging altogether.

While there are slight variations among card brands, general rules on surcharging remain universal. For example, presently, a surcharge fee can only apply to credit cards; furthermore, a surcharge fee cannot be charged to debit cards, even when a debit card is run like a credit card. Additional rules for surcharging include a percentage cap on what the merchant can charge as set by the payment card networks, and the merchant must have the proper signage informing customers of the surcharge.

While it is easy for a merchant to implement a surcharge program, there is no way to ensure that the amount collected in fees will cover the cost of processing.

Merchants can also offset the cost of processing fees by increasing their prices and offering a discount to those who pay with cash or check, commonly referred to as “Cash Discounting.” The Durbin Amendment, included as part of the 2010 Dodd-Frank law, permits businesses to legally offer a discount to those who pay with cash or check instead of a credit card.

Moreover, the Durbin Amendment states that payment card networks are not allowed to restrict a business's ability to offer cash and check payment discounts. It defines “discount” as a reduction made from the price that customers are informed is the regular price and does not include any means of increasing the price that customers are informed is the regular price.

Cash discount programs are simple by design. A merchant must post the credit price on shelves and menus or utilize dual pricing, showing both the cash and credit prices, and then offer a discount for customers that pay with cash.

Like surcharging, merchants implementing a cash discount program cannot ensure that the increased price covers the cost of processing, primarily due to how fees are charged, which presents a challenge when determining how much to charge and whether the additional amount collected impacts their profit margins.

Since the passing of the Durbin Amendment, many payment processing companies and merchant acquirers have developed merchant processing programs designed to offset the cost of processing fees.

One such program, the Non-Cash Adjustment (NCA) Program, charges a percentage of the total check—presented as a fee—to customers who pay with credit cards and debit cards. When customers pay with cash, the NCA fee is removed from the customer's check, or a discount is applied to the check to offset the fee. The card brands have ruled such programs non-compliant, stating that these programs violate network rules and are subject to surcharging rules. Merchants and acquirers implementing non-compliant programs caught violating the card brand rules are subject to fines.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

According to various embodiments, the invention and disclosure herein describe a useful, novel, and unobvious invention for a system and method that automatically determines a price (the “Listed Price”) that incorporates the item's cash price (the “Cash Price”)—set in a back-office management system—and the amount to cover the cost of processing card payments when selling the item at the point of sale. It also includes front-office point-of-sale functionality that displays the Cash Price(s) and Listed Price(s) based on the customer's payment method (either cash or card) or displays only the Listed Price(s) and adds a discount when the customer pays with cash. The user interface displays the total amount due based on the payment method—cash or card—and automatically charges the correct price based on the respective payment method.

The disclosed system and method automatically generate a price used for card payment transactions based on the Cash Price relative to a reduced price offered for cash-paying customers and the amount to cover the cost of processing card transactions. It allows operators and merchants to implement a pricing structure that considers the actual cost of processing card payments based on each item's Cash Price and its tax, if applicable. In doing so, at present, merchants are not subject to the rules of surcharging programs as determined by the payment card networks and comply with the laws of cash discounting.

Considering a reduced price offered to cash-paying customers (the “Cash Discount”) on a per-item basis, the system automatically calculates a Listed Price equal to the item's Cash Price plus the system's calculated amount to cover the cost of processing card payments. The back-office management system allows users to create and manage items. Users specify the item's tax profile by selecting whether the item is taxable or not. Based on tax profile selection (taxable/non-taxable) and the tax rate—and considering the Cash Discount amount and the Effective Processing Rate—the user can enter the Listed Price, and the system automatically generates the Cash Price, or the user can enter the Cash Price and the system automatically generates a Listed Price.

For items without tax, the system multiplies the Cash Price by a rate (the “Listed Price Rate”) to generate the Listed Price, which equals the amount the system charges for the item plus the amount to cover the cost of processing fees for the item on card-payment transactions.

For items that include tax, the system multiplies the Cash Price by a rate (the “Listed Price with Tax Rate”) to generate the Listed Price, which equals the amount the system charges for the item plus the amount to cover the cost of processing for the item and the item's tax on card-payment transactions.

The disclosed system and method also include a front-office point-of-sale display, herein referred to as the “Register,” which is a separate aspect of the system for entering orders and processing payments. In one embodiment, the Register consists of at least one interactive touchscreen display and a credit card reader. Registers can also be connected to receipt printers to print customer receipts.

When placing customer orders, users can tap items on the Register's touchscreen display to add items to the cart. Using the Cash Price(s) and/or the Listed Price(s), the Register calculates the total amount owed for all items in the cart based on each payment method (cash or card) and displays each amount at the bottom of the cart as totals labeled “Cash Due” and “Card Due.” The Cash Due and Card Due amounts include any discounts and tax, if applicable.

The disclosed system and method also allow users to choose between one of two account-level program settings: 1) Single Pricing, and 2) Dual Pricing. The two dynamic program types can be configured on an account level in the back-office management system settings. The type of program selected controls certain aspects of how the system functions concerning the Cash Price and Listed Price, how prices are displayed in the Register, and how prices and discounts are displayed on customer receipts.

The Single Pricing account-level setting only displays the item's Listed Price in the cart on the Register. If the customer pays with cash, the Cash Discount is applied to the order as a discount on the subtotal, resulting in a total cash payment due equal to the sum of the Cash Price for all items, less any discount plus tax (if applicable). The cart and the printed receipt display the per-item Listed Price with the Cash Discount shown below the subtotal to represent the price reduction applied to the order for paying with cash.

The Register's cart features an advanced calculator that dynamically computes the Remaining Cash Due and Remaining Card Due values and adjusted tax amounts after partial payment transactions. When a partial payment is accepted, the Register calculates payment ratios based on the proportion of the to the total respective amount due. For partial cash payments, Register applies a cash discount redeemed value (a product of the ratio and the Cash Discount) and recalculates the tax to compute the Remaining Card Due. For partial card payments, the Register reduces the cash discount by a proportion equal to the ratio of the card payment to the total amount due and recalculates the tax to compute the Remaining Cash Due. This precision ensures that discounts are accurately pro-rated based on the payment method and amount, and the tax amount is calculated correctly, maintaining fairness in mixed payment scenarios. The system's real-time calculations optimize the transaction process, benefiting both merchants and customers by providing transparent and equitable pricing adjustments.

In the back-office management system, users can edit the item's system-generated Listed Price, and the system automatically adjusts the Cash Price to equal the Listed Price less the discount for paying with cash.

The Dual Pricing account-level setting displays both the Listed Price and the Cash Price in the Register. Users can select between displaying the per-item Cash Price or the Listed Price in the cart on the Register using a segmented switch, a graphical display element with two positions, the first being a cash position and the second being a card position.

The per-item Cash Price is displayed in the cart if the switch is in the cash position.

The per-item Listed Price is displayed in the cart if the switch is in the card position.

When payment transactions are processed in the Register, the associated price per item-either the Cash Price or the Listed Price—is charged to the customer based on the respective payment method. If customers pay with cash, only the per-item Cash Price is displayed on the receipt, whereas if the customer pays with a card, only the per-item Listed Price is displayed on the receipt.

In the back-office management system, users can edit the item's system-generated Listed Price; there is no effect on the Cash Price.

### BRIEF DESCRIPTION OF THE SEVERAL VIEWS OF THE DRAWINGS

The foregoing summary, as well as the following detailed description of the disclosure, will be more fully understood by reference to the following drawings, which are for illustrative purposes only, and are not intended to limit the scope of the present disclosure. Also, it is appreciable that the drawings are not necessarily to scale as some components may be shown to be enlarged or out of proportion relative to the size in actual implementation to illustrate one or more concepts of the present disclosure more clearly. In the drawings:

FIG. 1 is an example embodiment of the system architecture for syncing item data between a back-office management system and the Register.

FIG. 2 illustrates an example embodiment of the formula determination process for conducting Listed Price calculations in the back-office management system of FIG. 1.

FIG. 3 is an example embodiment of the listed price process for price determination used to determine the system-generated Listed Price in the back-office management system of FIG. 1.

FIG. 4 is an example embodiment of the process for the user to edit the system-generated Listed Price in the back-office management system of FIG. 1 and its impact on the Cash Price based on the program type.

FIG. 5 is an example embodiment of the process for the system to display Listed Prices in the Register of FIG. 1 based on the program type and how users toggle between the item's Cash Price and Listed Price on the Dual Pricing program type.

FIG. 6 illustrates an example embodiment of a partial payment calculation process for handling partial cash payment amounts and partial card payment amounts, and calculating discounts to determine the remaining cash due and remaining card due.

### DETAILED DESCRIPTION

For the purpose of illustrating the disclosure, various embodiments are shown in the drawings. These example embodiments will now be described more fully with reference to the accompanying drawings wherein like reference numerals are used to denote like parts or portions throughout the description of the several views of the drawings.

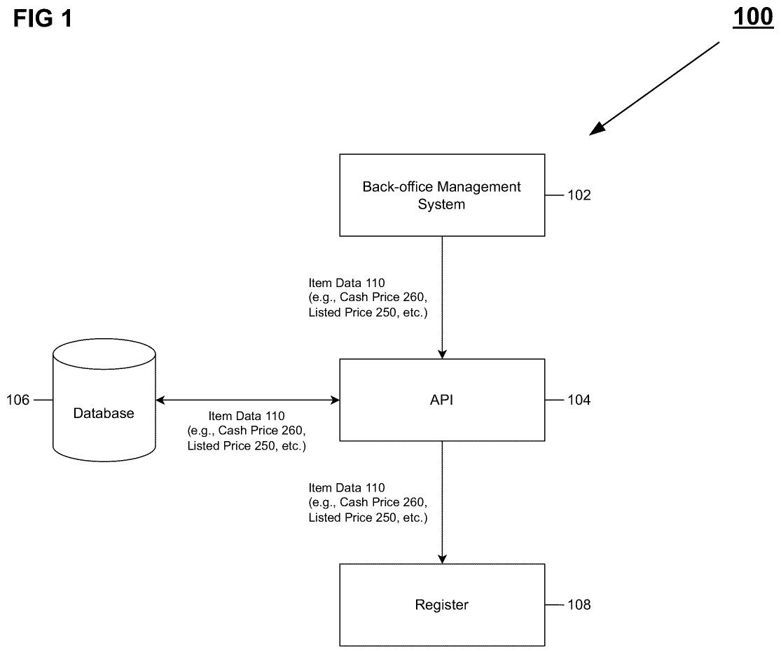

FIG. 1 illustrates a price determination system 100 comprising back-office management system 102, API 104, database 106, and Register 108. Using price determination system 100, item data 110, including without limitation the Cash Price (C) 260 and Listed Price (L) 250, can be synced between the back-office management system 102 and Register 108.

In one embodiment, the back-office management system 102 is connected to API 104 to sync item data 110, including without limitation item pricing information, to database 106. Register 108 is also connected to API 104 to sync item data 110, such as the Cash Price (C) 260 and Listed Price (L) 250, from database 106.

Register 108 is a front-office point-of-sale display for entering orders and processing payments. In one embodiment, Register 108 consists of at least one interactive touchscreen display and a credit card reader. Register 108 can also be connected to receipt printers to print customer receipts.

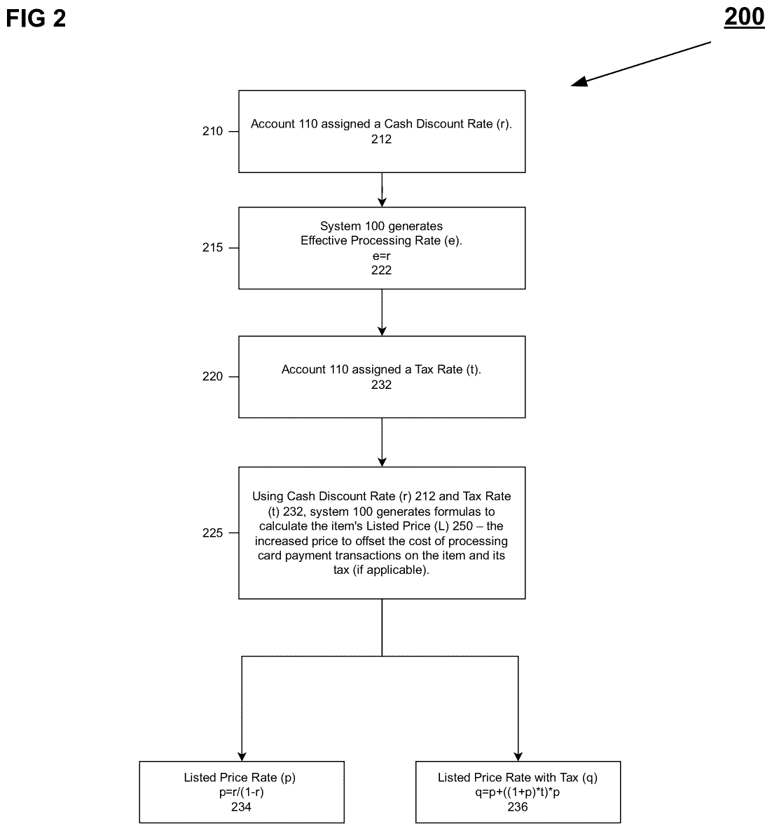

FIG. 2 illustrates an example embodiment of the formula determination process 200 used by price determination system 100 (FIG. 1) to determine the formulas for calculating the Listed Price (L) 250.

At Step 210, account 110 is assigned a Cash Discount Rate (r) 212. The Cash Discount Rate (r) 212 is the rate set by the user, such as the merchant or an administrator, to incentive cash payments. The formula determination process 200 then moves to Step 215.

At Step 215, price determination system 100 determines the Effective Processing Rate (e) 222 using formula determination process 200. The Effective Processing Rate (e) 222 is the processing rate the system charges for processing card payment transactions.

The Effective Processing Rate (e) 222 can be calculated using the following formula:

$$( e ) = ( r ) \qquad ( 1 )$$

Formula determination process 200 then moves to Step 220. At Step 220, account 110 is assigned a Tax Rate (t) 232. The Tax Rate (t) 232 is assigned to items with tax. Formula determination process 200 then moves to Step 225.

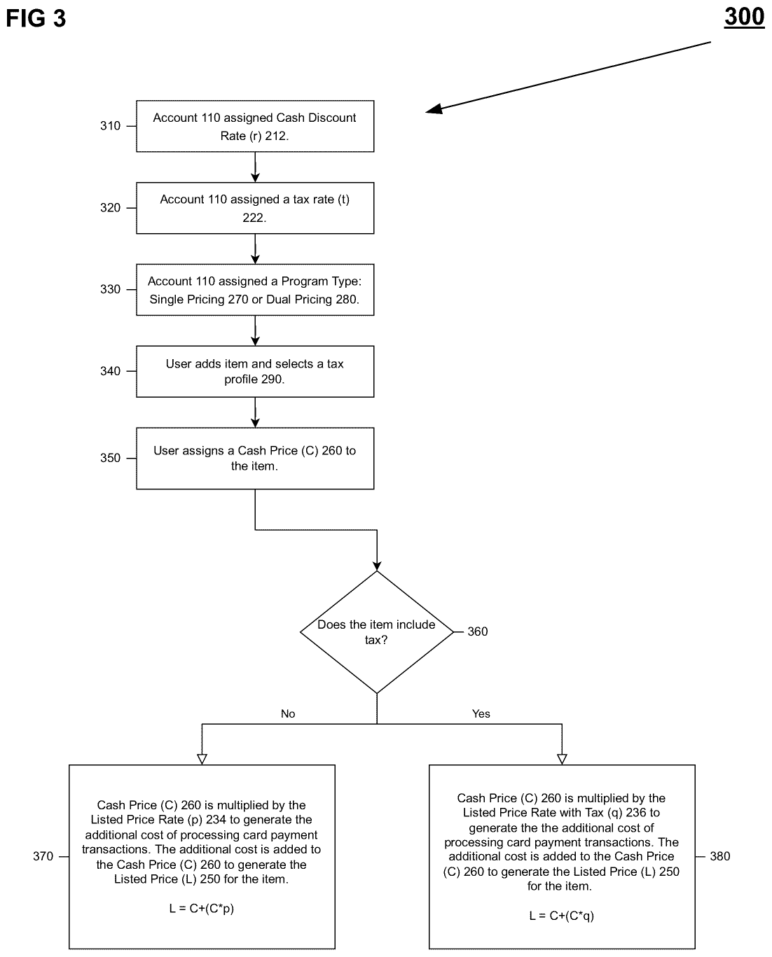

At Step 225, price determination system 100 generates formulas to calculate an item's Listed Price (L) 250 using the Cash Discount Rate (r) 212 and the Tax Rate (t) 232. The Listed Price (L) 250 is the increased price that includes the calculated amount to cover the cost of processing card payments on the item and its tax, if applicable. At Step 225, based on the user's selected settings and the item's tax profile of taxable or non-taxable, price determination system 100 determines either the Listed Price Rate (p) 234 or Listed Price Rate with Tax (q) 236 for use in listed price determination process 300 (FIG. 3) for calculating an item's Listed Price 250.

For the Listed Price Rate (p) 234, the system multiplies the Cash Price (C) 260 by the Listed Price Rate (p) 234 to calculate the additional amount to cover the cost of processing card payment transactions for non-taxable items.

The Listed Price Rate (p) 234 can be calculated using the following formula:

$$( p ) = ( r ) / ( 1 - ( r ) ) . \qquad ( 2 )$$

For the Listed Price Rate with Tax (q) 236, the system multiplies the Cash Price (C) 260 by the Listed Price Rate with Tax (q) 236 to calculate the additional cost to cover processing card payment transactions for taxable items.

The Listed Price Rate with Tax (q) 236 can be calculated using the following formula:

$$( q ) = ( p ) + ( ( ( 1 + ( p ) ) * ( t ) ) * ( p ) ) \qquad ( 3 )$$

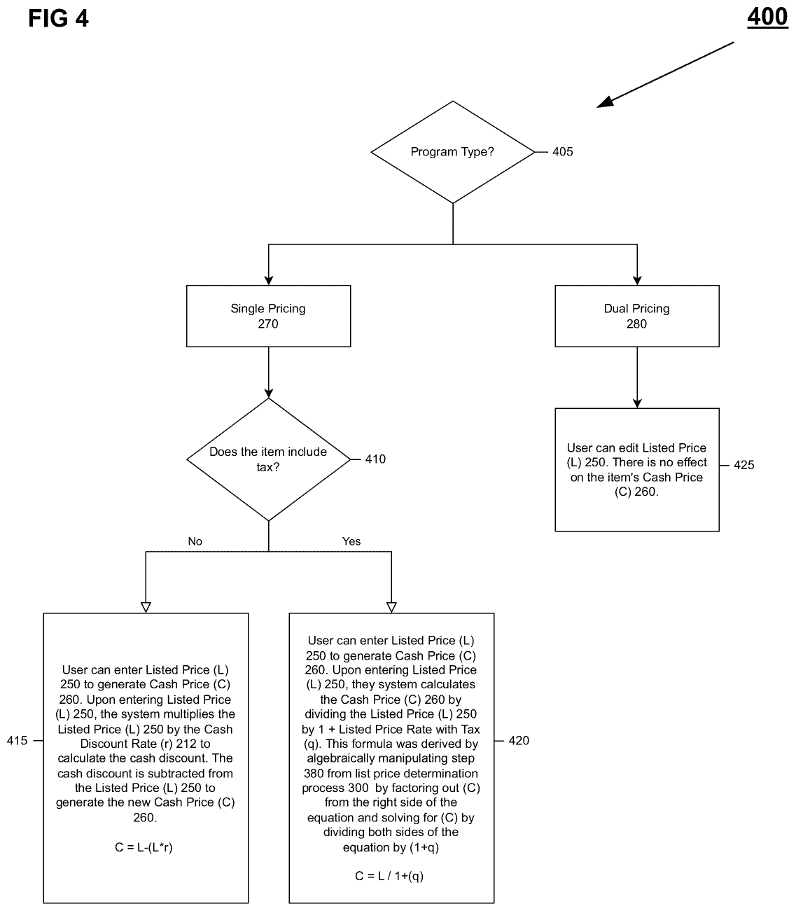

Account 110 is also assigned a program type. If Single Pricing 270 is selected, using the cash price determination process 400 (FIG. 4), the user can enter the system-generated Listed Price (L) 250 to generate the Cash Price (C) 260.

FIG. 3 illustrates an example embodiment of the listed price determination process 300 used to generate the Listed Price 250 with the formula from formula determination process 200.

At Step 310, account 110 is assigned the Cash Discount Rate (r) 212. Listed price determination process 300 then moves to Step 320.

At Step 320, account 110 is assigned the tax rate (t) 222. Listed price determination process 300 then moves to Step 330.

At Step 330, account 110 is assigned one of two account-level program settings: Single Pricing 270, which only displays the Listed Price (L) 250 in the Register 108, or Dual Pricing 280, which displays both the Cash Price (C) 260 and the Listed Price (L) 250 in the Register 108. Listed price determination process 300 then moves to Step 340.

At Step 340, the user, such as a merchant or an administrator, adds an item to account 110 and selects a tax profile 290 of taxable or non-taxable. Non-taxable items do not have tax, whereas taxable items do have tax. Listed price determination process 300 then moves to Step 350.

At Step 350, the user assigns the Cash Price (C) 260 to the item. Listed price determination process 300 then moves to Step 360.

At Step 360, price determination system 100 determines whether the item has tax based on the tax profile 290. If the item does not include tax, then listed price determination process 300 moves to Step 370. If the item does include tax, then listed price determination process 300 moves to Step 380.

At Step 370, the Cash Price (C) 260 is multiplied by the Listed Price Rate (p) 234 from formula determination process 200 to generate the additional amount to cover the cost of processing card payment transactions for items without tax. The additional cost is added to the Cash Price (C) 260 to generate the Listed Price (L) 250 for the item. The Listed Price (L) 250 for items without tax can be calculated using the following formula:

$$( L ) = ( C ) + ( ( C ) * ( p ) ) \qquad ( 4 )$$

At Step 380, Cash Price (C) 260 is multiplied by the Listed Price Rate with Tax (q) 236 from formula determination process 200 to calculate the additional amount to cover the cost of processing card payment transactions for items with tax. The additional amount is added to the Cash Price (C) 260 to generate the Listed Price (L) 250 for the item.

The Listed Price (L) 250 for items with tax can be calculated using the following formula:

$$( L ) = ( C ) + ( ( C ) * ( q ) ) \qquad ( 5 )$$

FIG. 4 illustrates an example embodiment of the cash price determination process 400 used to generate Cash Price (C) 260 from Listed Price (L) 250, as determined by listed price determination process 300, based on the program type. At Step 405, it is determined if the program type is set to Single Pricing 270 or Dual Pricing 280.

If Single Pricing 270 is selected, cash price determination process 400 moves to Step 410. At Step 410, the price determination system 100 determines if the item is taxable based on the item's tax profile 290. If the item does not include tax, then cash price determination process 400 moves to Step 415, where the user can enter the Listed Price (L) 250 to determine the Cash Price (C) 260. If Listed Price (L) is entered, the Cash Price (C) 260 is equal to the Listed Price (L) 250 less the cash discount using the following formula:

$$( C ) = ( L ) - ( ( L ) * ( r ) ) \qquad ( 6 )$$

If the item does include tax, then cash price determination process 400 instead moves to Step 420, where the user can enter the Listed Price (L) 250 to determine the Cash Price (C) 260. If a Listed Price (L) 250 is entered, the system derives the Cash Price (C) 260 by reverse engineering the formula at Step 380 from listed price determination process 300 by algebraically manipulating Step 380 from listed price determination process 300. This is done by factoring out (C) from the right side of the equation: (L)=(C)*(1+q) and then solving for (C) by dividing both sides of the equation by (1+q), yielding the following formula:

$$( C ) = ( L ) / ( 1 + ( q ) ) \qquad ( 7 )$$

Turning back to Step 405, if Dual Pricing 280 is selected, cash price determination process 400 instead moves to Step 425, where the user can enter Listed Price (L) 250 and still enter any amount for Cash Price (C) 260.

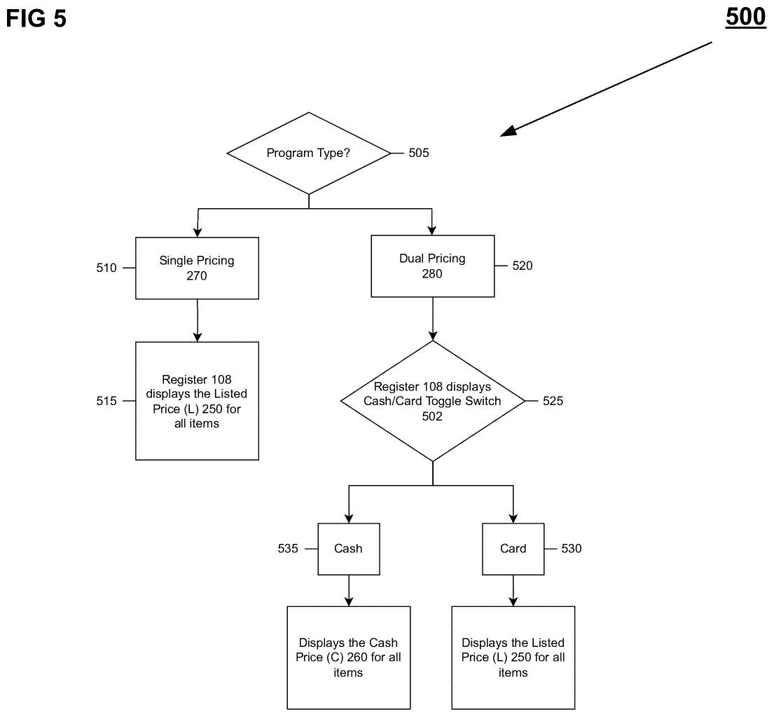

FIG. 5 illustrates an example embodiment of display determination process 500 used to determine how prices are displayed in the Register 108 of price determination system 100 with the account-level program type.

At Step 505, it is determined if the program type is set to Single Pricing 270 or Dual Pricing 280. If the program type is set to Single Pricing 270 at Step 510, display determination process 500 moves to Step 515, where Register 108 displays the Listed Price (L) 250 for all items.

If the program type is set to Dual Pricing at Step 520, display determination process 500 instead moves to Step 525, where Register 108 displays a Cash/Card Toggle Switch 502 in the cart. At Step 525, users can toggle between the Cash Price (C) 260 at Step 535 and the Listed Price (L) 250 at Step 530 using the Cash/Card Toggle Switch 502.

If the user toggles to the Cash Price (C) 260 at Step 535, then Register 108 displays the Cash Price (C) 260 for all items.

If the user toggles to the Listed Price (L) 250 at Step 530, then Register 108 displays the Listed Price (L) 250 for all items.

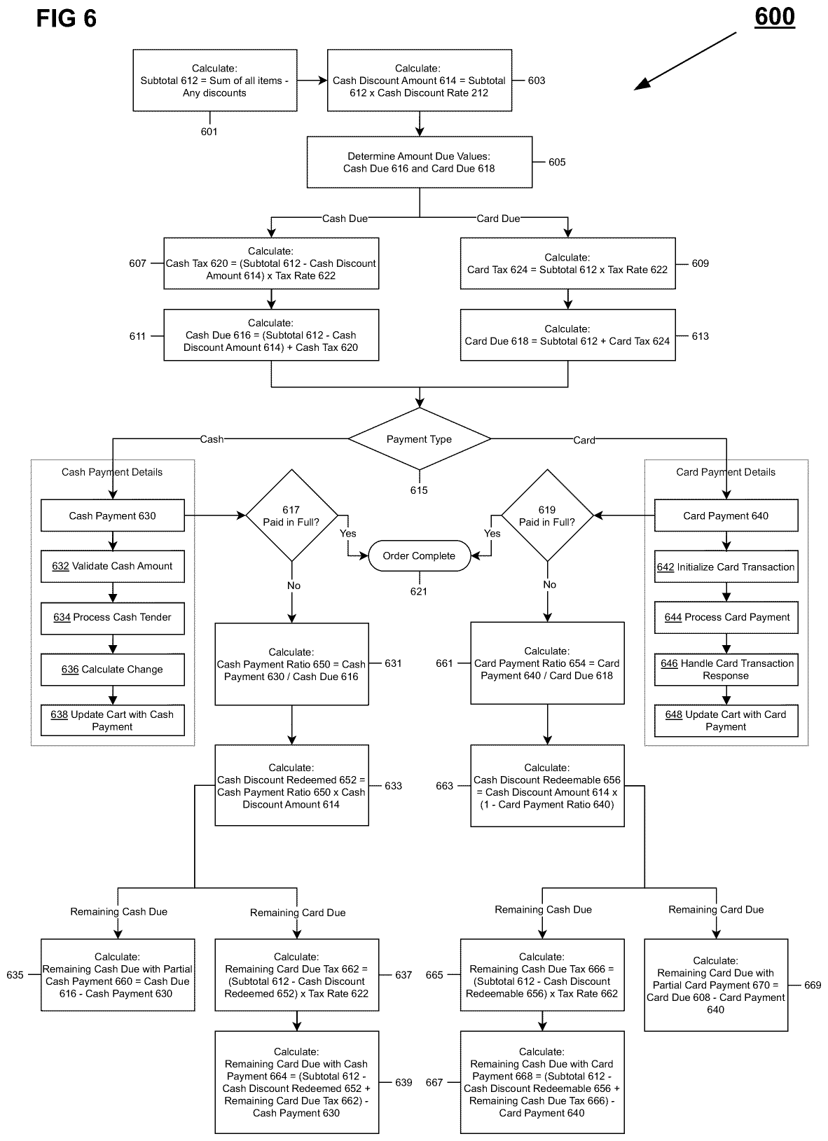

FIG. 6 illustrates an example embodiment of a partial payment calculation process 600 for handling cash payments and card payments when an order is not paid in full, proportionally discounting the cash discount and adjusting tax values to determine the Remaining Cash Due 690 and Remaining Card Due 692 amounts due for both cash and card payments. Partial payment calculation process 600 ensures that all remaining amounts due are properly calculated, considering partial payments, eligible cash discount and cash discount redeemed amounts, and taxes for both partial cash and card payment methods.

Partial payment calculation process 600 begins at Step 601 with system 100 calculating the Subtotal 612, which is the sum of all items purchased by a customer minus any discounts. Partial payment calculation process 600 then moves to Step 603, where the Cash Discount Amount 614 is calculated by multiplying the Subtotal 612 by the Cash Discount Rate 212.

Partial payment calculation process 600 then moves to Step 605, where system 100 determines the Cash Due 616 and Card Due 618, which are the amount due values.

To determine Cash Due 616, partial payment calculation process 600 moves to Step 607, where the Cash Tax 620 is calculated by multiplying the difference between Subtotal 612 and Cash Discount Amount 614 by the Tax Rate 622. At Step 611, the Cash Due 616 is calculated by adding the Cash Tax 620 to the difference between Subtotal 612 and Cash Discount Amount 614.

For calculating the Card Due 618 value, partial payment calculation process 600 moves to Step 609, where the Card Tax 624 is calculated by multiplying the Subtotal 612 by the Tax Rate 622. At Step 613, the Card Due 618 is calculated by adding the Card Tax 624 to the Subtotal 612.

At Step 615, system 100 determines the whether the payment type is a Cash Payment 630 or a Card Payment 640. For Cash Payment 630, the partial payment calculation process 600 moves to Step 632 to validate the cash amount. Partial payment calculation process 600 then proceeds to Step 634 to process the cash tender, Step 636 to calculate change, and Step 638 to update the cart with the cash payment 630 amount.

For Card Payment 640, partial payment calculation process 600 moves to Step 642 to initialize a card transaction. Partial payment calculation process 600 then proceeds to Step 644 to process the card payment, Step 646 to handle the card transaction response, and Step 648 to update the cart with the card payment 630 amount.

At Steps 617 and 619, system 100 checks if the cash payment 630 or card payment 640, respectively, is made in full. If yes, the order is marked complete at Step 621, and the partial payment process 600 ends. If not, the partial payment process 600 continues to calculate the Remaining Cash Due 690 and Remaining Card Due 692 amounts due for both cash and card payments.

For partial cash payments, at Step 631, the Cash Payment Ratio 650 is calculated by dividing the Cash Payment 630 by the Cash Due 616. At Step 633, the Cash Discount Redeemed 652 is calculated by multiplying the Cash Payment Ratio 650 by the Cash Discount Amount 614.

For partial card payments, at Step 661, the Card Payment Ratio 654 is calculated by dividing the Card Payment 640 by the Card Due 618. At Step 663, the Cash Discount Redeemable 656 is calculated by multiplying the Cash Discount Amount 614 by (1−Card Payment Ratio 654).

Partial payment calculation process 600 then proceeds to calculate the Remaining Cash Due 690 and Remaining Card Due 692 amounts due for both cash and card payments.

For partial cash payments, at Step 635, system 100 calculates the Remaining Cash Due 690 amount as Remaining Cash Due with Partial Cash Payment 660 using the following formula: Remaining Cash Due with Partial Cash Payment 660=Cash Due 616−Cash Payment 630.

System 100 determines the Remaining Card Due 692 amount via a two-step process. At Step 637, system 100 recalculates the tax based on the cash amount paid using the following formula: Card Due Tax 652=(Subtotal 612−Cash Discount Redeemed 652)*Tax Rate 622

At Step 639, system 100 calculates the Remaining Card Due 692 amount as Remaining Card Due with Cash Payment 664 using the formula: Remaining Card Due with Cash Payment 664=Subtotal 612−Cash Discount Redeemed 652+Remaining Card Due Tax 652−Cash Payment 630.

For partial card payments, System 100 determines the Remaining Cash Due 690 amount as Remaining Cash Due Tax 666 via a two-step process. First, at Step 665, system 100 recalculates the tax based the cash discount redeemed using the following formula: Remaining Cash Due Tax 666=(Subtotal 612−Cash Discount Redeemable 656)*Tax Rate 622.

Second, at Step 667, system 100 calculates the remaining cash due amount using the formula: Remaining Cash Due with Card Payment 668=Subtotal 612−Cash Discount Redeemable 656+Remaining Cash Due Tax 666−Card Payment 640

At Step 669, system 100 calculates the Remaining Card Due amount as Remaining Card Due with Partial Card Payment 670 using the following formula: Remaining Card Due with Partial Card Payment 670=Card Due 618−Card Payment 640.

While the invention has been specifically described in connection with certain specific embodiments thereof, it is to be understood that this is by way of illustration and not of limitation. Reasonable variations and modifications are possible within the scope of the foregoing disclosure and drawings without departing from the spirit of the invention.

What is claimed is:

1- A price determination system comprising:
a back-office management system for managing a plurality of item data of an item;
a database connected to the back-office management system to store the plurality of item data;
an API connected to the back-office management system and the database to sync the plurality of item data to the database from the back-office management system;
a register connected to the API; and
wherein the plurality of item data is synced between the back-office management system and the register using the API.

2- The price determination system of claim 1, wherein the plurality of item data comprises a cash price and a listed price.

3- The price determination system of claim 1, wherein the register comprises an interactive touchscreen display and a credit card reader.

4- The price determination system of claim 1, wherein the register is connected to a receipt printer to print customer receipts.

5- A method for formula determination to calculate a listed price comprising:
assigning a cash discount rate to an account, wherein the cash discount rate is the rate set by a user to incentive cash payments;
determining an effective processing rate, wherein the effective processing rate is the processing rate charged for processing card payment transactions;
assigning a tax rate to the account, wherein the tax rate is used for a tax on an item;
generating a formula to calculate a listed price of the item using the cash discount rate and the tax rate, wherein the listed price is the increased price that includes an amount to cover the cost of processing card payments on the item and the tax.

6- A method for listed price determination to generate a listed price comprising:
assigning a cash discount rate to an account, wherein the cash discount rate is the rate set by a user to incentive cash payments;
assigning a tax rate to the account, wherein the tax rate is used for a tax on an item;
assigning an account-level program setting;
adding the item to the account;
selecting a tax profile;
assigning a cash price to the item;
determining whether the item has tax using the tax profile;
generating an additional amount to cover the cost of processing card payment transactions;
adding the additional amount to the cash price to generate the listed price for the item.

7- The method of claim 6 wherein the account-level program setting comprises single pricing, and wherein single pricing displays the listed price and adds a cash discount if the user pays with cash.

8- The method of claim 7 further comprising entering the listed price by the user wherein the cash price will automatically generate to equal the listed price less the cash discount.

9- The method of claim 6 wherein the account-level program setting comprises dual pricing, and wherein dual pricing displays the cash price and the listed price.

10- The method of claim 9 further comprising toggling between the cash price and listed price using a segmented switch.

11- The method of claim 9 further comprising entering the listed price and cash price separately.

12- The method of claim 6 wherein the tax profile comprises taxable.

13- The method of claim 6 wherein the tax profile comprises non-taxable.

14- A method for adaptive payment processing, comprising:
processing a payment, wherein for a cash payment, a cash due amount is reduced by a payment amount; and for a card payment, a card due amount is reduced by the payment amount;
computing a payment ratio of the payment amount to a due amount;
calculating a cash discount redeemed value as a cash discount amount times the payment ratio, and calculating a remaining card due tax as a tax rate times a subtotal less the cash discount redeemed value;
calculating a cash discount redeemable value as the cash discount amount times one minus the payment ratio, and calculating the remaining cash due tax as the tax rate times the subtotal less the cash discount redeemable value; and
updating the remaining cash due amount and card due amount.

15- The method of claim 14, further comprising dynamically adjusting the cash discount redeemed and cash discount redeemable values using the payment ratio.

16- The method of claim 14, further comprising:
computing the remaining card due value by subtracting the cash discount redeemed,
updating the tax to the card due tax value; and
computing the remaining cash due value by updating the cash discount to cash discount redeemable value and the tax to the cash due tax value.
